(19) United States
(12) Patent Application Publication
(10) Pub. No.: US 2026/0075470 A1
(43) Pub. Date: Mar. 12, 2026

(54) ENABLING SEAMLESS ROAMING IN NEXT GENERATION WLANS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Frisco, TX (US); Vishnu Vardhan Ratnam, Frisco, TX (US); Yue Qi, Plano, TX (US); Bilal Sadiq, Plano, TX (US)

(21) Appl. No.: 19/321,070

(22) Filed: Sep. 5, 2025

Related U.S. Application Data
(60) Provisional application No. 63/694,020, filed on Sep. 12, 2024.
(60) Provisional application No. 63/697,641, filed on Sep. 23, 2024.
(60) Provisional application No. 63/710,961, filed on Oct. 23, 2024.
(60) Provisional application No. 63/724,606, filed on Nov. 25, 2024.
(60) Provisional application No. 63/767,816, filed on Mar. 6, 2025.
(60) Provisional application No. 63/781,768, filed on Apr. 1, 2025.
(60) Provisional application No. 63/802,363, filed on May 8, 2025.
(60) Provisional application No. 63/842,535, filed on Jul. 11, 2025.
(60) Provisional application No. 63/851,243, filed on Jul. 25, 2025.

(51) Int. Cl. H04W 36/00; H04W 8/08; H04W 84/12

(52) U.S. Cl. CPC H04W 36/0033; H04W 8/08; H04W 84/12

(57) ABSTRACT

Methods and apparatuses for enabling seamless roaming in next generation WLANs. A method of wireless communication performed by a station (STA) includes determining to roam from a first access point (AP) to a second AP. The method further includes receiving, from the first AP, context transfer feasibility information associated with a context that has been set up with the first AP, the context transfer feasibility information further associated with at least one candidate AP for the STA to roam to.

### CROSS-REFERENCE TO RELATED APPLICATION(S) AND CLAIM OF PRIORITY

This application claims priority under 35 U.S.C. § 119 (e) to U.S. Provisional Patent Application No. 63/694,020, filed on Sep. 12, 2024, U.S. Provisional Patent Application No. 63/697,641, filed on Sep. 23, 2024, U.S. Provisional Patent Application No. 63/710,961, filed on Oct. 23, 2024, U.S. Provisional Patent Application No. 63/724,606, filed on Nov. 25, 2024, U.S. Provisional Patent Application No. 63/767,816, filed on Mar. 6, 2025, U.S. Provisional Patent Application No. 63/781,768, filed on Apr. 1, 2025, U.S. Provisional Patent Application No. 63/802,363, filed on May 8, 2025, U.S. Provisional Patent Application No. 63/842,535, filed on Jul. 11, 2025, and U.S. Provisional Patent Application No. 63/851,243, filed on Jul. 25, 2025, each of which are hereby incorporated by reference in its entirety.

### TECHNICAL FIELD

This disclosure relates generally to wireless communication, and more specifically to enhancements for enabling seamless roaming in wireless local area networks (WLANs) including next generation WLANs.

### BACKGROUND

WLAN technology allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for RSSI measurement techniques for roaming in WLANs.

In one embodiment, a station (STA) comprises: a transceiver, and a processor operably coupled with the transceiver. The processor is configured to: determine to roam from a first access point (AP) to a second AP; and receive, via the transceiver from the first AP, context transfer feasibility information associated with a context that has been set up with the first AP, the context transfer feasibility information further associated with at least one candidate AP for the STA to roam to.

In another embodiment, a first AP comprises a transceiver, and a processor operably coupled with the processor. The processor is configured to: receive, via the transceiver, an indication that a station (STA) has determined to roam from the first AP to a second AP; and transmit, via the transceiver, context transfer feasibility information associated with a context that has been set up with the first AP, the context transfer feasibility information further associated with at least one candidate AP for the STA to roam to.

In yet another embodiment, a method of wireless communication performed by a STA includes determining to roam from a first AP to a second AP. The method further includes receiving, from the first AP, context transfer feasibility information associated with a context that has been set up with the first AP, the context transfer feasibility information further associated with at least one candidate AP for the STA to roam to.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example access point (AP) according to embodiments of the present disclosure;

FIG. 3 illustrates an example station (STA) according to embodiments of the present disclosure;

FIG. 4 illustrates an example of stages involved during a mobility handover procedure according to embodiments of the present disclosure;

FIG. 5 illustrates an example of a ranging round according to embodiments of the present disclosure;

FIG. 6 illustrates an example of a beacon interval according to embodiments of the present disclosure;

FIG. 7 illustrates an example feasibility check procedure according to embodiments of the present disclosure;

FIG. 8 illustrates an example call flow operation with multiple expiration dates according to embodiments of the present disclosure;

FIG. 9 illustrates an example call flow operation with multiple check for context transfer feasibility with same access points (APs) according to embodiments of the present disclosure;

FIG. 10 illustrates an example call flow operation with multi-step context transfer feasibility check with different APs according to embodiments of the present disclosure;

FIG. 11 illustrates an example call flow operation for context transfer with single expiration time according to embodiments of the present disclosure;

FIG. 12 illustrates an example call flow operation for context transfer with reject and not reject indication according to embodiments of the present disclosure;

FIG. 13 illustrates an example call flow operation with suggested parameters in addition to responses according to embodiments of the present disclosure;

FIG. 14 illustrates an example call flow operation when requesting a candidate neighbor AP list according to embodiments of the present disclosure;

FIG. 15 illustrates an example call flow operation when requesting neighbor APs in the same seamless roaming domain (SMD) according to embodiments of the present disclosure;

FIG. 16 illustrates an example call flow operation when requesting neighbor APs in a SMD according to embodiments of the present disclosure;

FIG. 17 illustrates an example call flow operation when requesting neighbor APs in the same SMD with lower basic service set (BSS) load than the current AP according to embodiments of the present disclosure;

FIG. 18 illustrates an example call flow operation when requesting neighbor APs in the same or different SMD with lower BSS load than the current AP according to embodiments of the present disclosure;

FIG. 19 illustrates an example SMD capabilities field format according to embodiments of the present disclosure;

FIG. 20 illustrates an example BSS transition management query frame action field format according to embodiments of the present disclosure;

FIG. 21 illustrates an example modified request mode field format according to embodiments of the present disclosure;

FIG. 22 illustrates an example capabilities subfield format according to embodiments of the present disclosure;

FIG. 23 illustrates an example BSSID information field format according to embodiments of the present disclosure; and

FIG. 24 illustrates an example method performed by a STA in a wireless communication system according to embodiments of the present disclosure.

### DETAILED DESCRIPTION

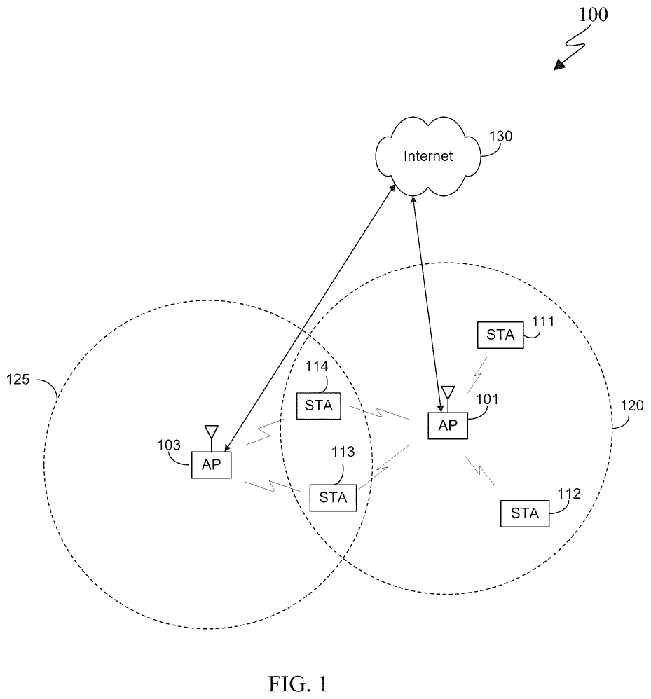

FIGS. 1 through 24, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE P802.11be/D3.0, 2023; [2] IEEE Std 802.11-2020.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the APs may include circuitry and/or programming for facilitating enhancements for enabling seamless roaming in WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

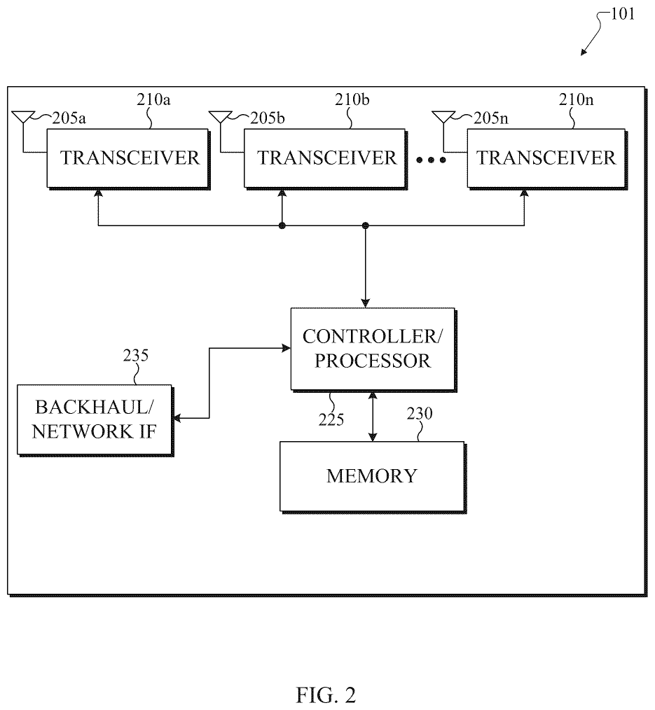

FIG. 2 illustrates an example AP 101 according to various embodiments of the present disclosure. The embodiment of the AP 101 illustrated in FIG. 2 is for illustration only, and the AP 103 of FIG. 1 could have the same or similar configuration. However, APs come in a wide variety of configurations, and FIG. 2 does not limit the scope of this disclosure to any particular implementation of an AP.

The AP 101 includes multiple antennas 205a-205n and multiple transceivers 210a-210n. The AP 101 also includes a controller/processor 225, a memory 230, and a backhaul or network interface 235. The transceivers 210a-210n receive, from the antennas 205a-205n, incoming radio frequency (RF) signals, such as signals transmitted by STAs 111-114 in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the AP 101. For example, the controller/processor 225 could control the reception of forward channel signals and the transmission of reverse channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing signals from multiple antennas 205a-205n are weighted differently to effectively steer the outgoing signals in a desired direction. The controller/processor 225 could also support OFDMA operations in which outgoing signals are assigned to different subsets of subcarriers for different recipients (e.g., different STAs 111-114). Any of a wide variety of other functions could be supported in the AP 101 by the controller/processor 225 including facilitating enhancements for enabling seamless roaming in WLANs. In some embodiments, the controller/processor 225 includes at least one microprocessor or microcontroller. The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the AP 101 to communicate with other devices or systems over a backhaul connection or over a network. The interface 235 could support communications over any suitable wired or wireless connection(s). For example, the interface 235 could allow the AP 101 to communicate over a wired or wireless local area network or over a wired or wireless connection to a larger network (such as the Internet). The interface 235 includes any suitable structure supporting communications over a wired or wireless connection, such as an Ethernet or RF transceiver. The memory 230 is coupled to the controller/processor 225. Part of the memory 230 could include a RAM, and another part of the memory 230 could include a Flash memory or other ROM.

As described in more detail below, the AP 101 may include circuitry and/or programming for facilitating enhancements for enabling seamless roaming in WLANs. Although FIG. 2 illustrates one example of AP 101, various changes may be made to FIG. 2. For example, the AP 101 could include any number of each component shown in FIG. 2. As a particular example, an access point could include a number of interfaces 235, and the controller/processor 225 could support routing functions to route data between different network addresses. Alternatively, only one antenna and transceiver path may be included, such as in legacy APs. Also, various components in FIG. 2 could be combined, further subdivided, or omitted and additional components could be added according to particular needs.

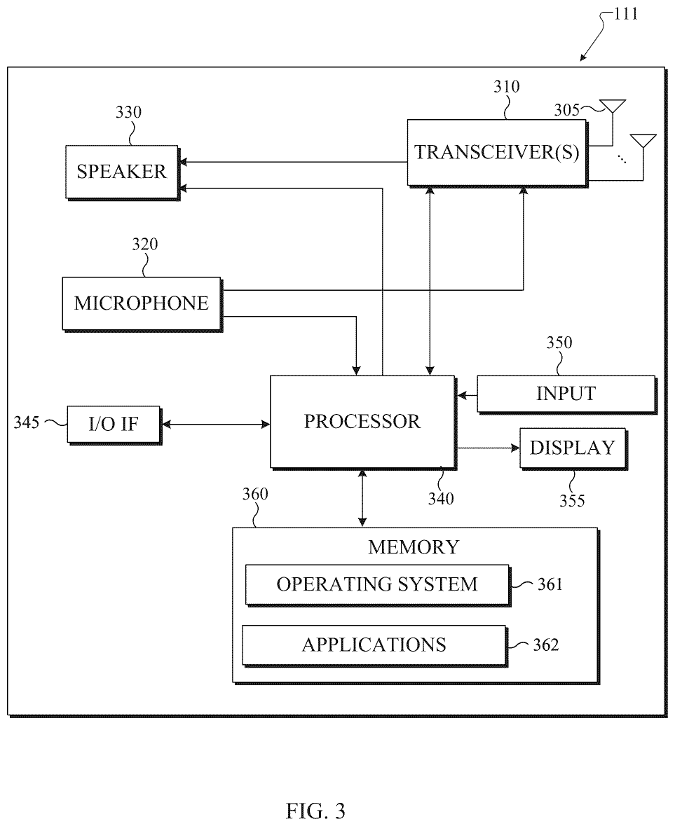

FIG. 3 illustrates an example STA 111 according to various embodiments of the present disclosure. The embodiment of the STA 111 illustrated in FIG. 3 is for illustration only, and the STAs 111-114 of FIG. 1 could have the same or similar configuration. However, STAs come in a wide variety of configurations, and FIG. 3 does not limit the scope of this disclosure to any particular implementation of a STA.

The STA 111 includes antenna(s) 305, transceiver(s) 310, a microphone 320, a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna(s) 305, an incoming RF signal (e.g., transmitted by an AP 101 of the network 100). The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors and execute the basic OS program 361 stored in the memory 360 in order to control the overall operation of the STA 111. In one such operation, the processor 340 controls the reception of forward channel signals and the transmission of reverse channel signals by the transceiver(s) 310 in accordance with well-known principles. The processor 340 can also include processing circuitry configured to facilitate enhancements for enabling seamless roaming in WLANs. In some embodiments, the processor 340 includes at least one microprocessor or microcontroller.

The processor 340 is also capable of executing other processes and programs resident in the memory 360, such as operations for facilitating enhancements for enabling seamless roaming in WLANs. The processor 340 can move data into or out of the memory 360 as required by an executing process. In some embodiments, the processor 340 is configured to execute a plurality of applications 362, such as applications for facilitating enhancements for enabling seamless roaming in WLANs. The processor 340 can operate the plurality of applications 362 based on the OS program 361 or in response to a signal received from an AP. The processor 340 is also coupled to the I/O interface 345, which provides STA 111 with the ability to connect to other devices such as laptop computers and handheld computers. The I/O interface 345 is the communication path between these accessories and the processor 340.

The processor 340 is also coupled to the input 350, which includes for example, a touchscreen, keypad, etc., and the display 355. The operator of the STA 111 can use the input 350 to enter data into the STA 111. The display 355 may be a liquid crystal display, light emitting diode display, or other display capable of rendering text and/or at least limited graphics, such as from web sites. The memory 360 is coupled to the processor 340. Part of the memory 360 could include a random-access memory (RAM), and another part of the memory 360 could include a Flash memory or other read-only memory (ROM).

Although FIG. 3 illustrates one example of STA 111, various changes may be made to FIG. 3. For example, various components in FIG. 3 could be combined, further subdivided, or omitted and additional components could be added according to particular needs. In particular examples, the STA 111 may include any number of antenna(s) 305 for MIMO communication with an AP 101. In another example, the STA 111 may not include voice communication or the processor 340 could be divided into multiple processors, such as one or more central processing units (CPUs) and one or more graphics processing units (GPUs). Also, while FIG. 3 illustrates the STA 111 configured as a mobile telephone or smartphone, STAs could be configured to operate as other types of mobile or stationary devices.

Embodiments of the present disclosure recognize that as users move around, the signal strength of a station (STA) to its connected access point (AP) can vary. If user movement causes a significant decrease in the signal strength, a handover is necessary. During the process of handover, the STA switches from its current associated AP to a new AP.

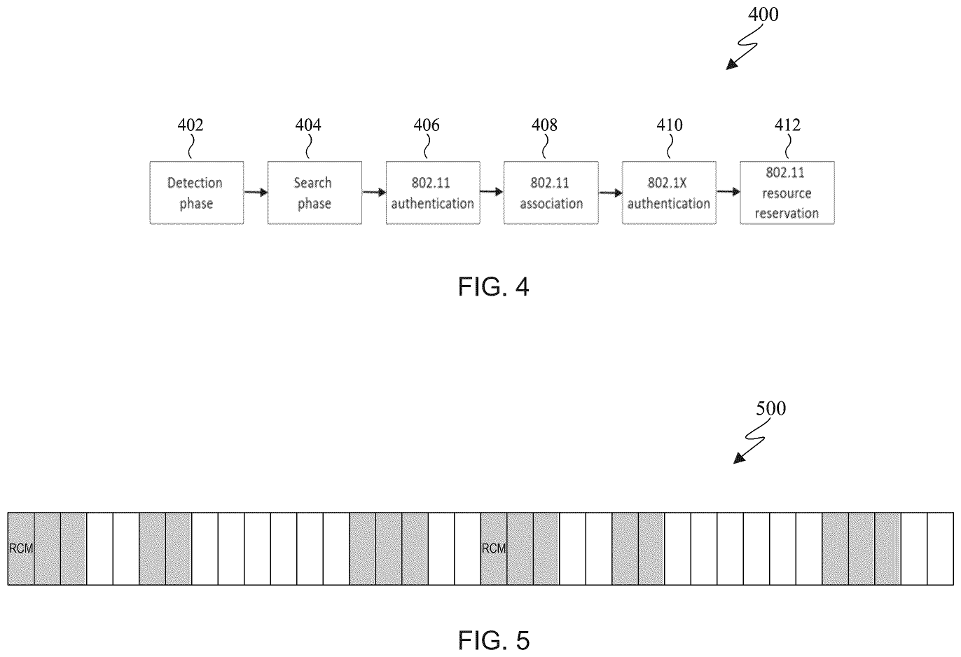

FIG. 4 illustrates an example of stages involved during a mobility handover procedure 400 according to embodiments of the present disclosure. For example, the mobility handover procedure 400 can be performed by any of the STAs 111-114, any of the APs 101, 103, and/or the network 130 of FIG. 1. The embodiment of the example of stages involved during a mobility handover procedure 400 shown in FIG. 4 is for illustration only. Other embodiments of the example of stages involved during a mobility handover procedure 400 could be used without departing from the scope of this disclosure.

As shown in FIG. 4, in devices without any mobility support, the handover procedure involves the following steps:
1. Detection phase: during the detection phase 402, the STA determines that there is a need for a handover, and is typically left to vendor implementation. For example, a particular vendor implementation can choose to trigger handover when the signal strength to the currently associated AP drops below a certain threshold.
2. Search phase: the detection phase 402 is followed by a search phase 404. During the search phase 404, the STA searches for new APs to associate with. During the search phase 404, the STA performs a scan of different channels to identify APs in the vicinity. This can be done either passively (e.g., listening to beacons on a particular channel) or actively (e.g., by the use of probe request and response procedures). Passive scan can take a lot of time as the scanning STA needs to wait on each channel for a sufficient amount of time to ensure that the beacon is received from APs on that channel. Since each AP transmits beacons after a certain period of time (e.g., 100 ms), passive scan can consume a lot of time. In the case of active scan, the STA transmits a probe request and waits for a probe response from APs in the vicinity. Without prior knowledge of APs in the vicinity, active scan can take several seconds to complete.
3. 802.11 authentication: after the scanning procedure is complete, the next step is to perform 802.11 authentication 406 (open system/shared key based), where the STA establishes its identity with the AP.
4. 802.11 association: Once the STA is authenticated, the next step is to perform association 408.
5. 802.1X authentication: Introduced in IEEE 802.1i amendment, the 802.1X authentication phase 410 comprises an EAP authentication between the STA and a AAA server with the assistance of the AP.
6. 802.11 resource reservation: Finally, in the 802.11 resource reservation phase 812, the STA sets up various resources at the new AP. For example, the STA can perform QoS reservation, BA setup, etc. with the newly associated AP.

Typically, during a handover, there can be a disruption in the connection as the setup procedure operates in a break-before-make manner. This can cause an impact on user experience especially with multimedia services which can suffer from session disruptions due to the high delay encountered during handover procedure.

In order to reduce the handover delay, a number of procedures have been introduced in several standards. The focus of these procedures is to remove/reduce the delay encountered in various steps of the handover procedure. In 2008, IEEE 802.11r introduced a fast transition roaming which eliminates the need for the authentication step 406 (step 3 above) during the handover. In 2011, IEEE 802.11k introduced assisted roaming which reduces the search phase 404 (step 2 above) by allowing the STA to request the AP to send channel information of candidate neighbor APs. In 2011, IEEE 802.11v also introduced network assisted roaming to assist the search phase 404. In IEEE 802.11be, the fast BSS transition procedure was extended to cover the case of MLO operation. This procedure helps to reduce the delays encountered due to 802.11 resource reservation (step 6 above). However, the STA still needs to perform the association and authentication phases which can take 10 s of ms.

### Co-Ex (Coexistence):

Wi-Fi devices can have a number of Wi-Fi and non-Wi-Fi radios that can co-exist on the same device. Some non-Wi-Fi technology radios which can co-exist with Wi-Fi are as stated blow:

### Bluetooth Operation:

Bluetooth is a wireless technology that started off as a short-distance cable replacement mechanism. Bluetooth classic is used for streaming applications (e.g., headset) operates on 79 RF channels each spaced 1 MHz apart. Bluetooth low energy (BLE) on the other hand is used for IoT applications and operates on 40 RF channels each spaced 2 MHz apart. In the case of Bluetooth, some channels are reserved specifically for the purpose of advertisement and others are used for secondary advertisement for data transmission. In the case of Bluetooth classic, 32 channels are reserved for advertisement whereas in the case of BLE 3 channels are reserved for advertisement.

In Bluetooth transmission happens as a part of a connection event. During a connection event, two devices that are engaged in data transmission alternate sending data until the data to be sent on both sides is exhausted. One of the devices acts as the master and the other device acts as the slave. The master sends a packet to the slave and if the slave receives the packet it sends back a packet to the master. The duration between two connection events is called a connection interval. Connection interval values range from 7.5 ms to 4 s. The exact value can be negotiated between the master and the slave to optimize their power saving while balancing latency incurred. Bluetooth transmissions follow a frequency hopping spread spectrum method where a hopping sequence is used to rapidly hop between data channels.

As Bluetooth and Wi-Fi follow different channel access protocols, coexistence of Bluetooth can lead to interference to Wi-Fi transmission. Some Bluetooth transmissions can be scheduled making the interference more predictable. However, in other cases, Bluetooth interference can be hard to predict in advance. Thus, Wi-Fi needs to have mechanisms to react to Bluetooth interference when it occurs in such cases.

Today Bluetooth is used for a large number of applications such as streaming applications, sensor applications, way finding based on beaconing, etc. Wi-Fi routers from a few vendors also come equipped with Bluetooth radios for the purpose of way finding/location awareness applications. Further, an end user's phone can also be configured as a Mobile AP which can also have Bluetooth operating on it.

Bluetooth has primarily operated on 2.4 GHz band. However, in next generation Bluetooth technology, the operation may be extended to 5 GHz and 6 GHz band as well. Thus, the interference problem can be worse for Wi-Fi operation which also uses these bands for communication.

### Ultra-Wideband Operation:

FIG. 5 illustrates an example of a ranging round 500 according to embodiments of the present disclosure. The embodiment of the ranging round 500 shown in FIG. 5 is for illustration only. Other embodiments of the ranging round 500 could be used without departing from the scope of this disclosure.

Ultra-Wide Band (UWB) has recently become popular for use cases involving indoor positioning and navigation using the 6 GHz band. The 802.15.4 amendment defines a block-based mode for ranging in which there are ranging blocks which are divided into ranging rounds which are further divided into ranging slots. The number of ranging rounds in a ranging block, the number of ranging slots in a ranging round and the duration of ranging slot are transmitted by the controller in a ranging control message (RCM) to the participant devices. The information can be for a current ranging round and potential subsequent ranging rounds as well. A ranging slot in which the device is expected to be active is referred to as active slots. There can also be inactive and silent periods.

An example ranging round is shown in FIG. 5, where the active slots are shown as shaded and the inactive slots are shown in white.

### Zigbee

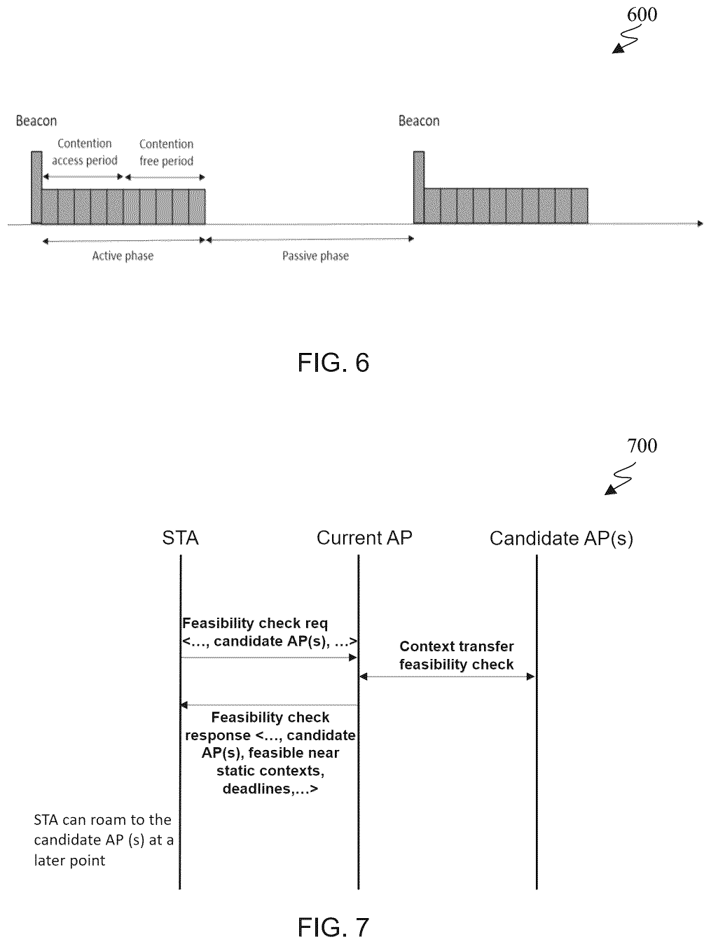

FIG. 6 illustrates an example of a beacon interval 600 according to embodiments of the present disclosure. The embodiment of the beacon interval 600 shown in FIG. 6 is for illustration only. Other embodiments of the beacon interval 600 beacon interval 600 could be used without departing from the scope of this disclosure.

ZigBee protocol is another technology developed for smart home applications. The protocol operates based on the concept of beacon intervals. The coordinator in a ZigBee operation sends out periodic beacons. Each beacon is followed by the start of an active phase. The beacon announced the duration of the active phase and the time until the next beacon transmission. Each beacon interval thus is divided into two phases—1. active phase which starts right after the beacon; and 2. passive phase for power save. The active phase can be divided into a contention-based period and a contention free period. The duration of each of the phases and the beacon interval can be characterized by aBaseSlotDuration value, macBeaconOrder (BO) and macSuperframeOrder (SO). BO and SO are integer values ranging from 0 to 14. The beacon interval can be computed as aBaseSuperframeDuration*2^{BO} and the active phase can be computed as aBaseSuperframeDuration*2^{SO} where aBaseSuperframeDuration=16*aBaseSlotDuration.

An example timeline is as shown in FIG. 6, where the active phase starts right after the beacon and in the illustrated embodiment, the active phase is divided into a contention-based period and a contention free period.

### Primary and Non-Primary Channel

Under the current wideband channel usage in Wi-Fi, channels are divided into primary and secondary channels. For 802.11 transmission to occur on a wideband, the primary channel must be idle. If the primary channels are busy, the secondary channels cannot be accessed.

### A. Context Transfer Feasibility Check

Embodiments of the present disclosure recognize that when a STA communicates with an AP, the STA may have setup a number of contexts with the current AP. Examples can be as shown in Table 1.

TABLE 1
Contexts and their categorization

| Context | Type |
|---|---|
| Sequence Number (SN) | Dynamic |
| Packet Number (PN) | Dynamic |
| Block ACK (BA) parameters (e.g., SN) | Dynamic |
| BA setup | Near Static |
| SCS/MSCS | Near Static |
| EPCS | Near Static |
| TWT and variants (rTWT, bTWT, individual | Near Static |
| TWT, etc.) | |
| P2P TWT/CoEx Sessions | Near Static |
| Power Save: Dynamic SMPS, UPSD, WNM, Intra | Near Static |
| PPDU PS, etc. | |
| EMLSR setup | Near Static |
| EMLMR setup | Near Static |
| PHY Capabilities | Near Static |

Embodiments of the present disclosure recognize that when a STA roams from one AP to another AP, one or more of the contexts setup with the prior AP may be transferred to the new AP. However, the new AP may not accept all the contexts from the prior AP as is. This may need the STA to either setup the features with the new AP again possibly with degraded parameters. For example, AP1 supports an SCS with QoS requirements stating a delay bound of 15 ms but AP2 rejects the delay bound and can only support 30 ms. This may need the STA to operate with the 30 ms delay bound which can degrade the application running on the STA side which needs a 15 ms delay bound support.

It can be beneficial if prior to roam, the STA can check for the feasibility to transfer its already setup context with other candidate APs. A procedure to perform such a check is necessary.

### RSSI Measurement Techniques for Roaming

Embodiments of the present disclosure recognize that prior to roaming, a device may need to go off channel and perform RSSI measurements. However, this can disrupt the communication with the ongoing AP as the device goes off channel to perform these RSSI measurements. Current procedures can require the device to stay off channel for a long period of time (e.g., as the device sends probe request and awaits a probe response for it; both of which need a channel access). Procedures that can enable quick RSSI measurements and enable the device to return to its main channel quickly are necessary.

### Unavailability Handling for Roaming in Next Generation WLANs

Embodiments of the present disclosure recognize that when a device is operating under Co-Ex constraint, it can inform the AP about its unavailability. The unavailability indication can be provided via a number of methods such as ICF/ICR exchange, P2P TWT based signaling, etc. When a STA informs the AP about its unavailability, the AP may stop sending frames to the STA and during the unavailability duration. However, when the STA is unavailable, a roam point may be triggered (e.g., due to low RSSI). As a result, the STA may decide to suspend the non-Wi-Fi radio and perform frame exchanges (e.g., roaming related procedures, downlink frame retrieval, etc.) with the current AP. A procedure is needed to handle this scenario.

Accordingly, embodiments of the present disclosure provide mechanisms for (i) context transfer feasibility check; (ii) RSSI measurement techniques for roaming; and (iii) unavailability handling for roaming in next generation WLANs.

### (i) Context Transfer Feasibility Check

Embodiments of the present disclosure provide mechanisms for (i) feasibility check/AP recommendation procedure; (ii) example call flows; (iii) context transfer feasibility check support indication; and (iv) example signaling.

### (ii) RSSI Measurement Techniques for Roaming

Embodiments of the present disclosure provide mechanisms for handling RSSI measurements in next generation WLANs.

(iii) Unavailability Handling for Roaming in Next Generation WLANs

Embodiments of the present disclosure provide mechanisms for (i) pause/termination of Co-Ex; (ii) roaming related exception; and (iii) implicit indication.

### A. Context Transfer Feasibility Check

### Feasibility Check/AP Recommendation Procedure

FIG. 7 illustrates an example feasibility check procedure 700 according to embodiments of the present disclosure. The feasibility check procedure 700 of FIG. 7 can be performed by any of the STAs 111-114 of FIG. 1, such as the STA 111 of FIG. 3, and any of the APs 101, 103 of FIG. 1. The embodiment of the feasibility check procedure 700 shown in FIG. 7 is for illustration only. Other embodiments of the feasibility check procedure 700 could be used without departing from the scope of this disclosure.

According to some embodiments, as illustrated in FIG. 7, the STA can perform a feasibility check to see if the contexts setup with the current AP can be transferred to the candidate APs or if they can be acceptable to the candidate APs. This information can be useful when making an AP selection.

The STA can transmit a context transfer feasibility check request message to the current AP. The message can include at least one or more of the information items as indicated in Table 2.

TABLE 2
Information items that can be present in the
context transfer feasibility check message

| Information items | Description |
|---|---|
| Context transfer | One or more information items(s) that can |
| feasibility check | indicate that this is a request for a |
| indication | context transfer feasibility check. |
| Candidate AP | One or more information item(s) that can |
| identifier | indicate the candidate AP identifier, for |
| | example, BSSIDs of the candidate APs. |
| Preferred | One or more information item(s) that can |
| contexts | indicate the preferred contexts. For example, |
| | a field (e.g., a bit) for each context wherein |
| | a predetermined value (e.g., 1) can indicate |
| | the preference for a particular context and |
| | another predetermined value (e.g., 0) can |
| | indicate no preference. |
| Deadline | One or more information item(s) that can |
| | indicate the time by which the AP can complete |
| | the communication with other APs and send a |
| | response. |

Upon receiving the message, the current AP can communicate with the candidate APs mentioned in the request message. The current AP can check which candidate AP can take which context, their preferred parameter setting, etc. Upon completion of this check, the current AP can transmit a context transfer feasibility check response message to the STA.

The response message can include one or more of the information items as indicated in Table 3.

TABLE 3
Context transfer feasibility check response message

| Information | |
|---|---|
| items | Description |
| Context transfer | One or more information items(s) that can |
| feasibility | indicate that this is a response message that |
| check indication | provides candidate AP(s) |
| Candidate AP(s) | One or more information item(s) that can |
| identifier | indicate the candidate AP identifier, for |
| | example BSSIDs of the candidate APs. To clarify, |
| | there can be more than one AP in the list |
| Feasible near | One or more information item(s) that can |
| static context | indicate the near static context transfer |
| | feasibility. For example, a bit map that can |
| | indicate which contexts can be transferred and |
| | which cannot be, an element that can make |
| | this indication, a field (e.g., a bit) that |
| | can take a predetermined value (e.g., 1) to |
| | indicate that the context transfer is feasible |
| | (e.g., providing QoS assurance) and to another |
| | predetermined value (e.g., 0) to indicate |
| | otherwise, etc. |
| Deadline | One or more information item(s) that can |
| | indicate a deadline for the context transfer |
| | feasibility indication. For example, a deadline |
| | for each AP's indication, an overall deadline, |
| | etc. |

The response message can be transmitted in an unsolicited manner as well. For example, the current AP can find that the signal strength of a STA is weak, and it can roam to another AP. The current AP can check with potential candidate APs and can transmit an unsolicited context transfer feasibility check message to the STA.

According to some embodiments, the context transfer feasibility check can also be a request for recommending neighbor APs where the context can be transferred. According to this embodiment, the STA can transmit a feasibility check request message indicating that it intends to discover APs in the neighborhood where its context can be transferred.

According to some embodiments, the feasibility check request message can also enable the STA to discover APs in the neighborhood which are more suitable for its needs considering a number of factors such as traffic type, delay requirements, preferred BSS load, etc.

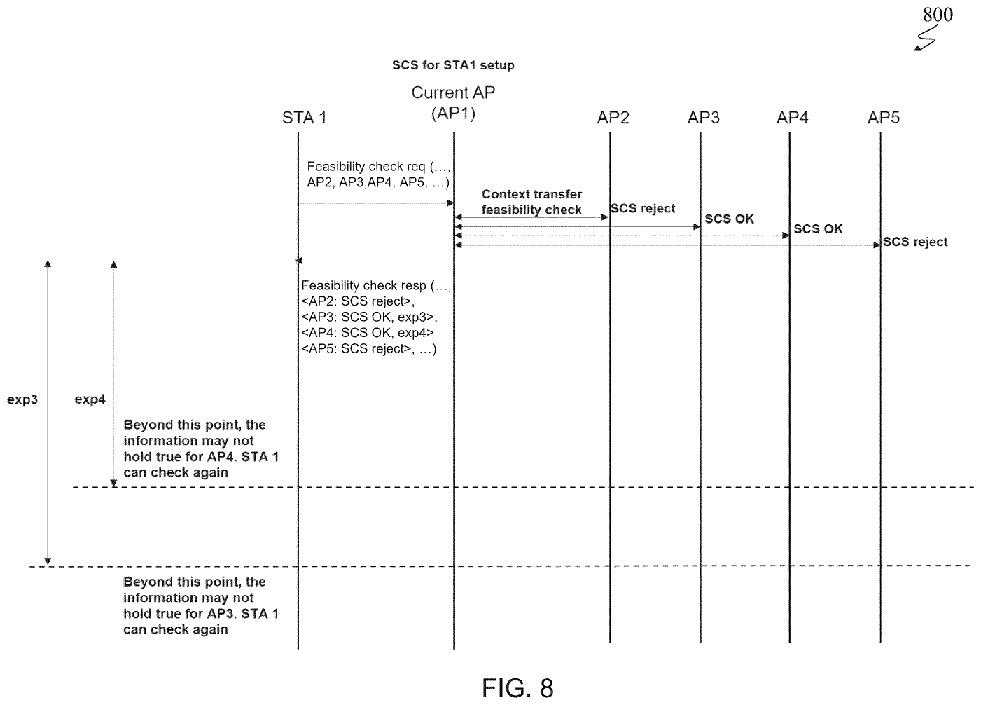

FIG. 8 illustrates an example call flow operation 800 with multiple expiration dates according to embodiments of the present disclosure. The call flow operation 800 of FIG. 8 can be performed by any of the STAs 111-114 of FIG. 1, such as the STA 111 of FIG. 3, and any of the APs 101, 103 of FIG. 1. The embodiment of the call flow operation 800 shown in FIG. 8 is for illustration only. Other embodiments of the call flow operation 800 could be used without departing from the scope of this disclosure.

According to some embodiments, as illustrated in FIG. 8, the STA can perform a feasibility check to see if the contexts setup with the current AP can be transferred to the candidate APs or if they can be acceptable to the candidate APs. This information can be useful when making an AP selection.

The STA can transmit a context transfer feasibility check request message to the current AP. In some embodiments, the context transfer feasibility check request message can have a list of candidate APs. If the context transfer feasibility check request message does not have a list of candidate APs, then all the neighbor APs can be checked. Upon receiving the message, the current AP can communicate with the candidate APs mentioned in the request message. The current AP can check which candidate AP can take which context, their preferred parameter setting, etc. Upon completion of this check, the current AP can transmit a context transfer feasibility check response message to the STA. The response message can include information associated with the SCS for the APs and can also include expiration points such that beyond the expiration point, the information regarding certain APs, such as AP3 and AP4 in this example, may not hold true. In that case, the STA can check again regarding the APs taking the context.

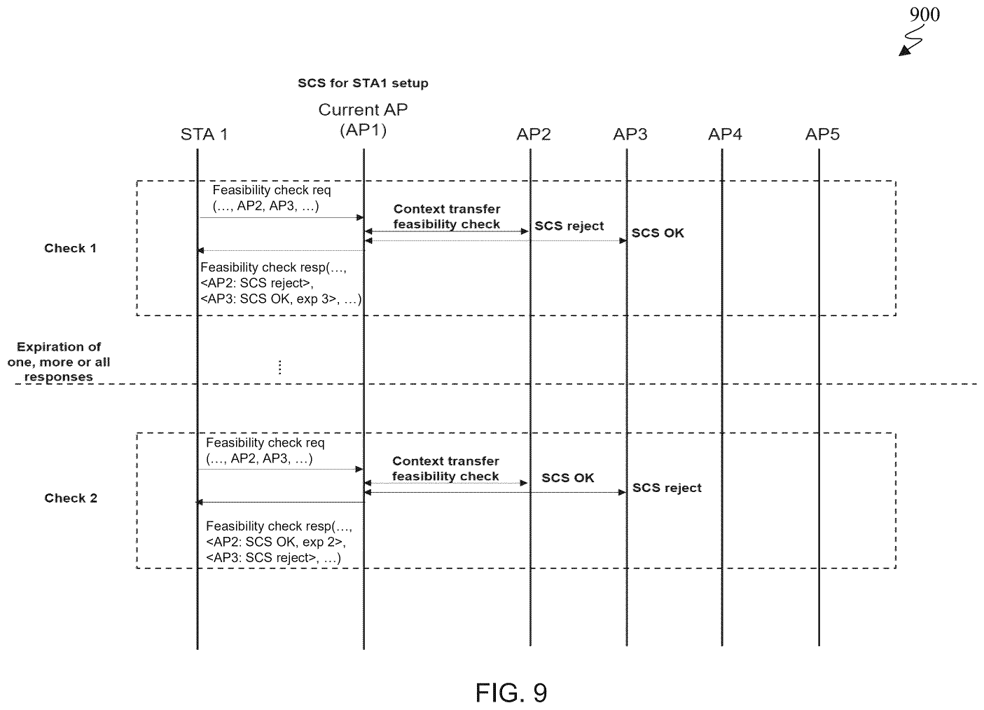

FIG. 9 illustrates an example call flow operation 900 with multiple checks for context transfer feasibility with same access points (APs) according to embodiments of the present disclosure. The call flow operation 900 of FIG. 9 can be performed by any of the STAs 111-114 of FIG. 1, such as the STA 111 of FIG. 3, and any of the APs 101, 103 of FIG. 1. The embodiment of the call flow operation 900 shown in FIG. 9 is for illustration only. Other embodiments of the call flow operation 900 could be used without departing from the scope of this disclosure.

According to some embodiments, as illustrated in FIG. 9, the STA can perform a feasibility check to see if the contexts setup with the current AP can be transferred to the candidate APs or if they can be acceptable to the candidate APs.

As described herein, the STA can transmit a context transfer feasibility check request message to the current AP. The current AP can check which candidate AP can take which context, their preferred parameter setting, etc. In the example shown in FIG. 9, the context can be associated with stream classification service (SCS). Upon completion of this check, the current AP can transmit a context transfer feasibility check response message to the STA. The response message can include information associated with the SCS for the APs and can also include expiration points such that beyond the expiration point, the information regarding certain APs, such as AP2 and AP3 in this example, may not hold true. In that case, the STA can check again regarding the APs taking the context.

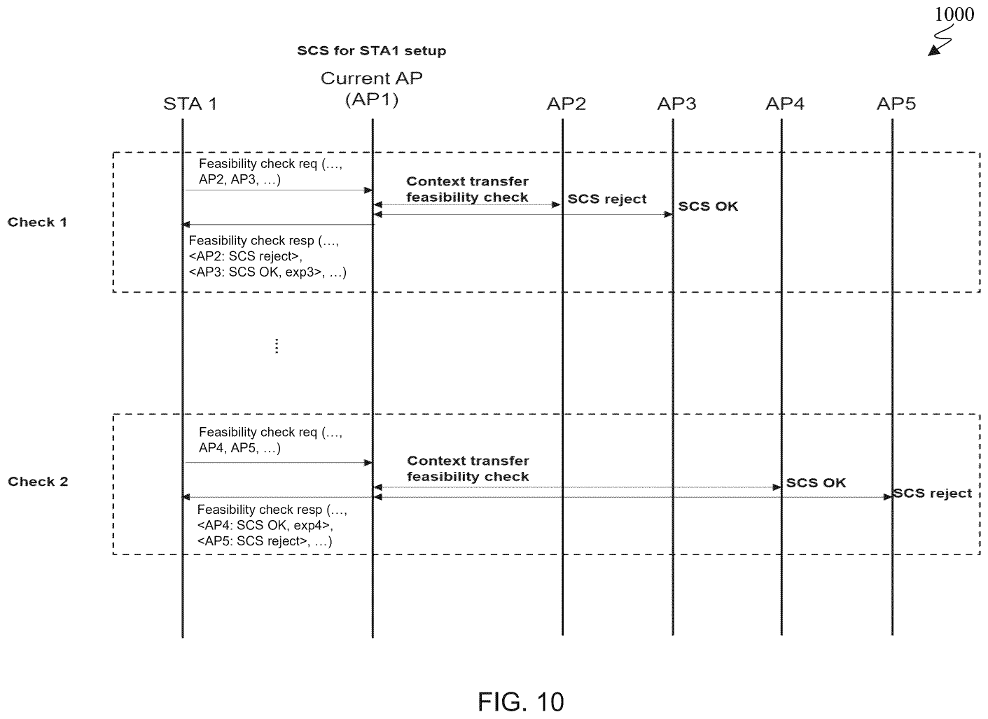

FIG. 10 illustrates an example call flow operation 1000 with multi-step context transfer feasibility check with different APs according to embodiments of the present disclosure. The call flow operation 1000 of FIG. 10 can be performed by any of the STAs 111-114 of FIG. 1, such as the STA 111 of FIG. 3, and any of the APs 101, 103 of FIG. 1. The embodiment of the call flow operation 1000 shown in FIG. 10 is for illustration only. Other embodiments of the call flow operation 1000 could be used without departing from the scope of this disclosure.

According to some embodiments, as illustrated in FIG. 10, the STA can perform a feasibility check to see if the contexts setup with the current AP can be transferred to the candidate APs or if they can be acceptable to the candidate APs.

As described herein, the STA can transmit a context transfer feasibility check request message to the current AP. The current AP can check which candidate AP can take which context, their preferred parameter setting, etc. In the example shown in FIG. 10, the context can be associated with SCS, and the feasibility check can be performed multiple times with different APs. For example, a first check can be performed with AP2 and AP3, and a second check can be performed with AP4 and AP5. Upon completion of each of the checks, the current AP can transmit a context transfer feasibility check response message to the STA. The response message can include information associated with the SCS for the APs and can also include expiration points such that beyond the expiration point, the information regarding certain APs, such as AP3 and AP4 in this example, may not hold true. In that case, the STA can check again regarding the APs taking the context.

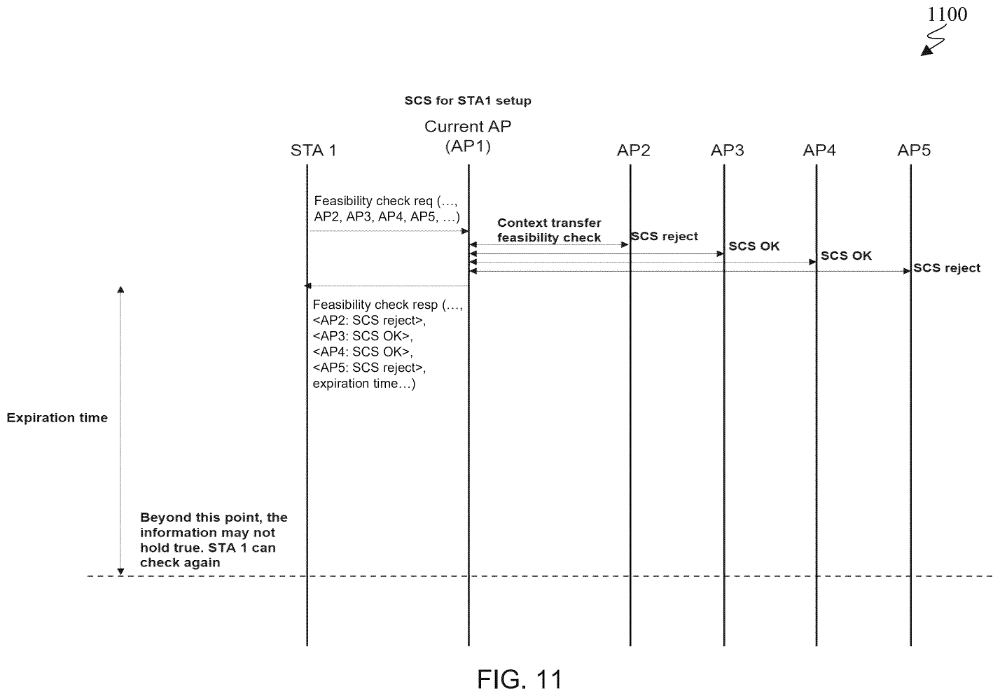

FIG. 11 illustrates an example call flow operation 1100 for context transfer with single expiration time according to embodiments of the present disclosure. The call flow operation 1100 of FIG. 11 can be performed by any of the STAs 111-114 of FIG. 1, such as the STA 111 of FIG. 3, and any of the APs 101, 103 of FIG. 1. The embodiment of the call flow operation 1100 shown in FIG. 11 is for illustration only. Other embodiments of the call flow operation 1100 could be used without departing from the scope of this disclosure.

According to some embodiments, as illustrated in FIG. 11, the STA can perform a feasibility check to see if the contexts setup with the current AP can be transferred to the candidate APs or if they can be acceptable to the candidate APs.

As described herein, the STA can transmit a context transfer feasibility check request message to the current AP. The current AP can check which candidate AP can take which context, their preferred parameter setting, etc. In the example shown in FIG. 11, the context can be associated with SCS. Upon completion of this check, the current AP can transmit a context transfer feasibility check response message to the STA. The response message can include information associated with the SCS for the APs and can also include a single expiration point such that beyond the expiration point, the information regarding the APs may not hold true. In that case, the STA can check again regarding the APs taking the context.

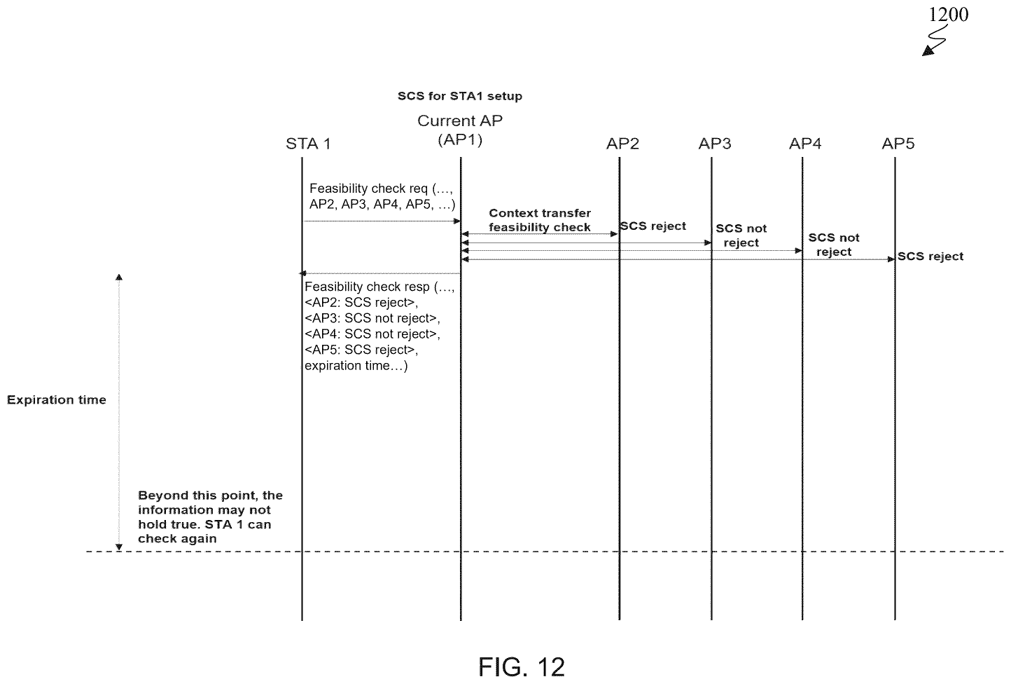

FIG. 12 illustrates an example call flow operation 1200 for context transfer with reject and not reject indication according to embodiments of the present disclosure. The call flow operation 1200 of FIG. 12 can be performed by any of the STAs 111-114 of FIG. 1, such as the STA 111 of FIG. 3, and any of the APs 101, 103 of FIG. 1. The embodiment of the call flow operation 1200 shown in FIG. 12 is for illustration only. Other embodiments of the call flow operation 1200 could be used without departing from the scope of this disclosure.

According to some embodiments, as illustrated in FIG. 12, the STA can perform a feasibility check to see if the contexts setup with the current AP can be transferred to the candidate APs or if they can be acceptable to the candidate APs.

As described herein, the STA can transmit a context transfer feasibility check request message to the current AP. The current AP can check which candidate AP can take which context, their preferred parameter setting, etc. In the example shown in FIG. 12, the context can be associated with SCS. Upon completion of this check, the current AP can transmit a context transfer feasibility check response message to the STA. The response message can include information associated with the SCS in the form of SCS reject and SCS not reject for the APs and can also include a single expiration point such that beyond the expiration point, the information regarding the APs may not hold true. In that case, the STA can check again regarding the APs taking the context.

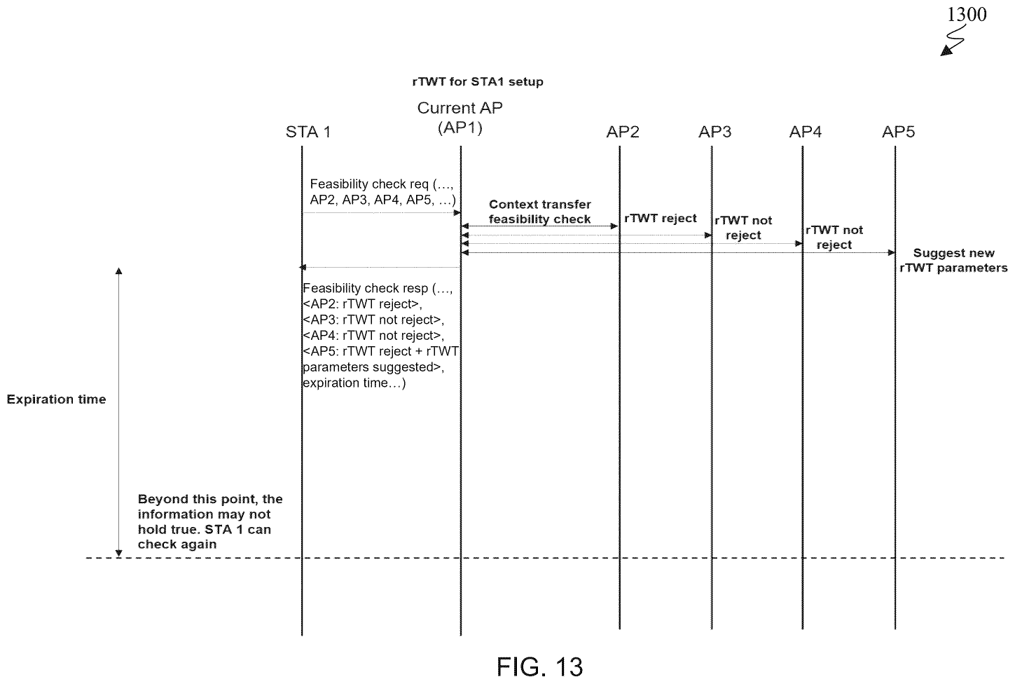

FIG. 13 illustrates an example call flow operation 1300 with suggested parameters in addition to responses according to embodiments of the present disclosure. The call flow operation 1300 of FIG. 13 can be performed by any of the STAs 111-114 of FIG. 1, such as the STA 111 of FIG. 3, and any of the APs 101, 103 of FIG. 1. The embodiment of the call flow operation 1300 shown in FIG. 13 is for illustration only. Other embodiments of the call flow operation 1300 could be used without departing from the scope of this disclosure.

According to some embodiments, as illustrated in FIG. 13, the STA can perform a feasibility check to see if the contexts setup with the current AP can be transferred to the candidate APs or if they can be acceptable to the candidate APs.

As described herein, the STA can transmit a context transfer feasibility check request message to the current AP. The current AP can check which candidate AP can take which context, their preferred parameter setting, etc. In the example shown in FIG. 13, the context can be associated with restricted target wake time (rTWT). Upon completion of this check, the current AP can transmit a context transfer feasibility check response message to the STA. The response message can include information associated with the rTWT in the form of rTWT reject and rTWT not reject for the APs and can also include a single expiration point such that beyond the expiration point, the information regarding the APs may not hold true. In that case, the STA can check again regarding the APs taking the context.

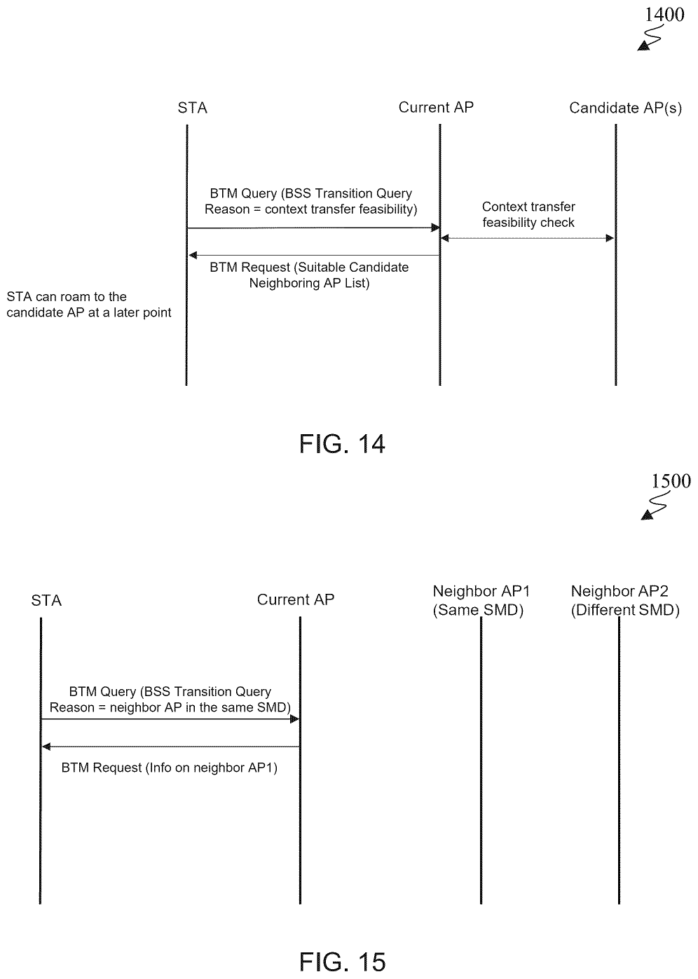

FIG. 14 illustrates an example call flow operation 1400 when requesting a candidate neighbor AP list according to embodiments of the present disclosure. The call flow operation 1400 of FIG. 14 can be performed by any of the STAs 111-114 of FIG. 1, such as the STA 111 of FIG. 3, and any of the APs 101, 103 of FIG. 1. The embodiment of the call flow operation 1400 shown in FIG. 14 is for illustration only. Other embodiments of the call flow operation 1400 could be used without departing from the scope of this disclosure.

According to some embodiments, as illustrated in FIG. 14, the STA can transmit a message in the form of a basic service set transition management (BTM) query which contains an indication in the form of a query reason that requests the current AP to transmit information related to its neighbor APs. As illustrated in FIG. 14, the query reason can be associated with context transfer feasibility, and the request for information can be associated with context transfer feasibility. The STA can receive a message in the form of a BTM request from the current AP which can contain an indication of a suitable candidate neighboring AP list.

FIG. 15 illustrates an example call flow operation 1500 when requesting neighbor APs in the same seamless roaming domain (SMD) according to embodiments of the present disclosure. The call flow operation 1500 of FIG. 15 can be performed by any of the STAs 111-114 of FIG. 1, such as the STA 111 of FIG. 3, and any of the APs 101, 103 of FIG. 1. The embodiment of the call flow operation 1500 shown in FIG. 15 is for illustration only. Other embodiments of the call flow operation 1500 could be used without departing from the scope of this disclosure.

According to some embodiments, as illustrated in FIG. 15, the STA can transmit a message in the form of a BTM query which contains an indication in the form of a query reason that requests the current AP to transmit information related to its neighboring APs. As illustrated in FIG. 15, the query reason can be associated with neighboring APs in the same SMD. The STA can receive a message in the form of a BTM request from the current AP which can contain an indication on the neighboring APs in the same SMD (e.g., AP1 in this example).

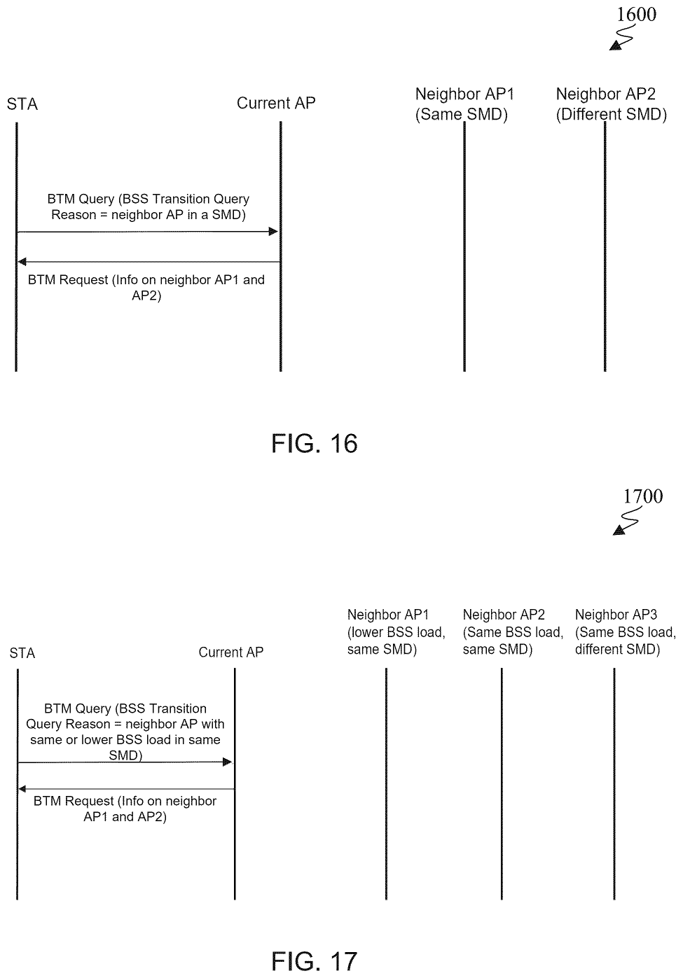

FIG. 16 illustrates an example call flow operation 1600 when requesting neighbor APs in a SMD according to embodiments of the present disclosure. The call flow operation 1600 of FIG. 16 can be performed by any of the STAs 111-114 of FIG. 1, such as the STA 111 of FIG. 3, and any of the APs 101, 103 of FIG. 1. The embodiment of the call flow operation 1600 shown in FIG. 16 is for illustration only. Other embodiments of the call flow operation 1600 could be used without departing from the scope of this disclosure.

According to some embodiments, as illustrated in FIG. 16, the STA can transmit a message in the form of a BTM query which contains an indication in the form of a query reason that requests the current AP to transmit information related to its neighboring APs. As illustrated in FIG. 16, the query reason can be associated with neighboring APs in an SMD. The STA can receive a message in the form of a BTM request from the current AP which can contain an indication on the neighboring APs in the SMD (e.g., AP1 and AP2 in this example).

FIG. 17 illustrates an example call flow operation 1700 when requesting neighbor APs in the same SMD with lower BSS load than the current AP according to embodiments of the present disclosure. The call flow operation 1700 of FIG. 17 can be performed by any of the STAs 111-114 of FIG. 1, such as the STA 111 of FIG. 3, and any of the APs 101, 103 of FIG. 1. The embodiment of the call flow operation 1700 shown in FIG. 17 is for illustration only. Other embodiments of the call flow operation 1700 could be used without departing from the scope of this disclosure.

According to some embodiments, as illustrated in FIG. 17, the STA can transmit a message in the form of a BTM query which contains an indication in the form of a query reason that requests the current AP to transmit information related to its neighboring APs. As illustrated in FIG. 17, the query reason can be associated with neighboring APs with the same or lower BSS load in the same SMD. The STA can receive a message in the form of a BTM request from the current AP which can contain an indication on the neighboring APs (e.g., AP1 and AP2 in this example).

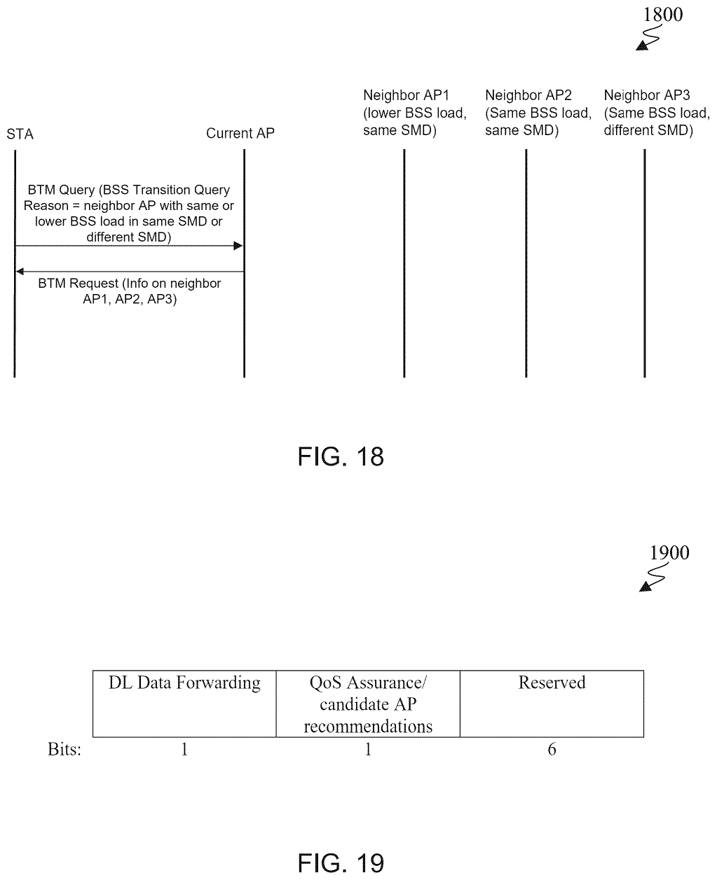

FIG. 18 illustrates an example call flow operation when requesting neighbor APs in the same or different SMD with lower BSS load than the current AP according to embodiments of the present disclosure. The call flow operation 1800 of FIG. 18 can be performed by any of the STAs 111-114 of FIG. 1, such as the STA 111 of FIG. 3, and any of the APs 101, 103 of FIG. 1. The embodiment of the call flow operation 1800 shown in FIG. 18 is for illustration only. Other embodiments of the call flow operation 1800 could be used without departing from the scope of this disclosure.

According to some embodiments, as illustrated in FIG. 18, the STA can transmit a message in the form of a BTM query which contains an indication in the form of a query reason that requests the current AP to transmit information related to its neighboring APs. As illustrated in FIG. 18, the query reason can be associated with neighboring APs with the same or lower BSS load in the same SMD or a different SMD. The STA can receive a message in the form of a BTM request from the current AP which can contain an indication on the neighboring APs (e.g., AP1, AP2, and AP3 in this example).

### Context Transfer Feasibility Check Support Indication

An AP that can support a context transfer feasibility check can make an indication to the STA. The indication can be made via an advertisement of the support. For example, the indication can be made via a capability bit in the beacon or probe response frames.

FIG. 19 illustrates an example SMD capabilities field format 1900 according to embodiments of the present disclosure. The embodiment of the SMD capabilities field format 1900 1900 shown in FIG. 19 is for illustration only. Other embodiments of the SMD capabilities field format 1900 could be used without departing from the scope of this disclosure.

In some embodiments, as illustrated in FIG. 19, the capability bit can be present in the SMD capabilities field of the SMD information element.

The QoS Assurance bit can be set to 1 to indicate that the AP MLDs in the SMD have the capability to provide QoS assurance. This can enable the non-AP MLD to transmit a BTM query with query reason set to candidate AP recommendations.

### Example Signaling

### Request Message Example Signaling

According to some embodiments, a new transition and transition query reason value can be defined as shown in Table 4.

TABLE 4
Transition and Transition Query reasons

| Transition | |
|---|---|
| Reason value | Description |
| . . . (existing values) | . . . (existing values) |
| 22 | Requesting neighbor APs/discovery |
| 23 | Requesting neighbor APs in a seamless roaming domain |
| 24 | Requesting neighbor APs in the same seamless roaming domain as the |
| | current AP |
| 25 | Requesting suitable neighbor APs in the same seamless roaming domain as |
| | the current AP (e.g., context transfer is feasible). Here context transfer |
| | feasibility can also mean QoS assurance. This can also be a request for APs |
| | that can provide an assurance that the same SCS/QOS (i.e., same delay |
| | bound values and similar QoS treatment) as the current AP. This can also |
| | be called as candidate AP recommendations. |
| 26 | Requesting APs that have similar levels of BSS load (or any other load |
| | related metric) as the current AP. This can be a request for APs that are in |
| | the same seamless roaming domain. |
| 27 | Requesting APs that have similar or lower levels or just lower levels of |
| | BSS load (or any other load related metric) as the current AP. This can be |
| | a request for APs that are in the same seamless roaming domain. |
| 28 | Requesting APs that have similar levels of BSS load (or any other load |
| | related metric) as the current AP. This can be a request for APs that are in |
| | a different seamless roaming domain (e.g., a neighbor domain). The APs |
| | can be APs in the same FT domain but different seamless roaming domains |
| | or SMDs. The request can be just for APs in a different seamless roaming |
| | domain or can be for APs that are neighbor APs in both same and different |
| | seamless roaming domain. |
| 29 | Requesting APs that have lower levels of BSS load (or any other load |
| | related metric) as the current AP. This can be a request for APs that are in |
| | a different seamless roaming domain (e.g., a neighbor domain). The APs |
| | can be APs in the same FT domain but different seamless roaming domains |
| | or SMDs. The request can be just for APs in a different seamless roaming |
| | domain or can be for APs that are neighbor APs in both same and different |
| | seamless roaming domain. |
| 30 | Requesting suitable neighbor APs in a different or neighbor seamless |
| | roaming domain as the current AP (e.g., context transfer is feasible). Here |
| | context transfer feasibility can also mean QoS assurance. This can also be |
| | a request for APs that can provide an assurance that the same SCS/QoS |
| | (i.e., same delay bound values and similar QoS treatment) as the current |
| | AP. The request can be just for APs in a different seamless roaming domain |
| | or can be for APs that are neighbor APs in both same and different seamless |
| | roaming domain. |
| 31 | Providing candidate AP recommendation. These recommended APs can |
| | also be the APs where the links are feasible to be setup and the near static |
| | context (e.g., SCS) can be transferred. |
| 32 | Providing information on neighbor APs when any of their information has |
| | been updated (e.g., BSS load). |
| 31-255 | Reserved |

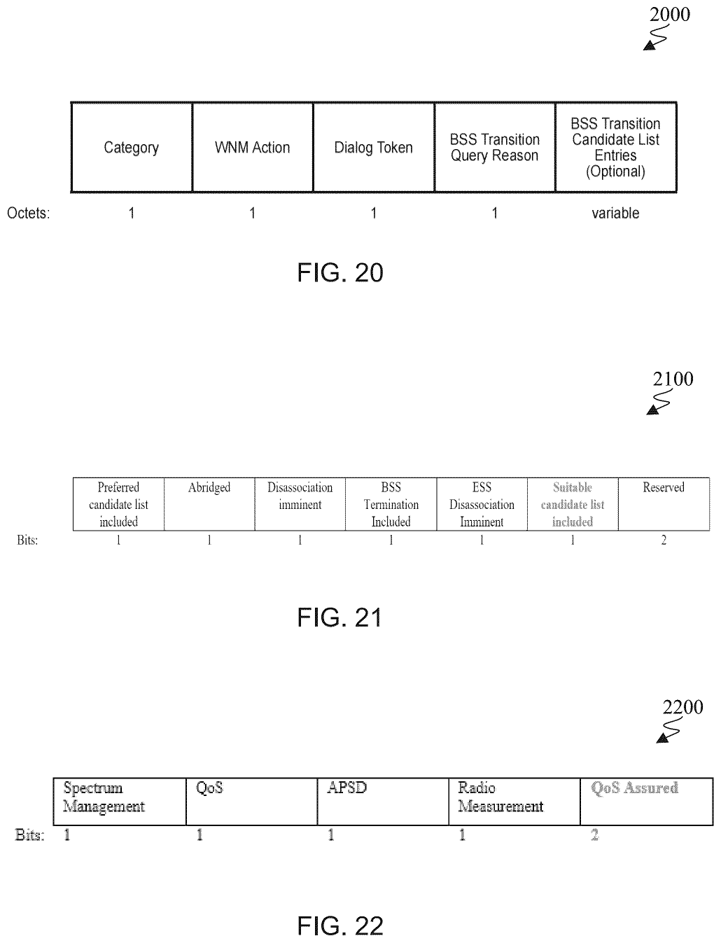

FIG. 20 illustrates an example BSS transition management query frame action field format 2000 according to embodiments of the present disclosure. The embodiment of the BSS transition management query frame action field format 2000 shown in FIG. 20 is for illustration only. Other embodiments of the BSS transition management query frame action field format 2000 could be used without departing from the scope of this disclosure.

The BSS Transition Query Reason can take a value as shown in Table 4.

In the BTM query frame, in the BSS transition candidate list entries, the non-AP MLD can include a list of neighboring APs for which it is requesting the information.

According to some embodiments, when the BSS Transition Query Reason is set to a value to indicate a suitable neighbor AP recommendation, then the current AP MLD can identify the AP MLDs in the neighborhood which can be suitable for the non-AP MLD as per the non-AP MLD's requirements, for example, context transfer feasibility.

According to some embodiments, when the BSS Transition Query Reason is set to a value to indicate a suitable neighbor AP recommendation and the BSS transition candidate list entries carries neighbor reports/information of neighbor APs, then the current AP MLD can find suitable neighbor APs out of the indicated list.

### Response Message Example Signaling 1

FIG. 21 illustrates an example modified request mode field format 2100 according to embodiments of the present disclosure. The embodiment of the modified request mode field format 2100 shown in FIG. 21 is for illustration only. Other embodiments of the modified request mode field format 2100 could be used without departing from the scope of this disclosure.

As illustrated in FIG. 21, according to some embodiments, the BSS transition management request frame can carry information on suitable neighbor APs. According to this embodiment, there can be a modified request mode field that can carry an indication regarding the suitable candidate list being included in the response message.

According to some embodiments, the indication can be provided in the preferred candidate list included subfield.

According to another embodiment, the indication can be provided by using one of the reserved fields as shown in FIG. 20.

When the indication is provided the BTM request frame can contain a list of neighboring AP MLDs that are suitable for the non-AP MLD. The indication can be provided via an RNR element inclusion. According to another embodiment, a basic multi-link element can be included.

According to some embodiments, the BTM request frame can be transmitted in an unsolicited manner. According to one embodiment, the modified request mode action field can indicate if a reason code can be included in the BTM request frame. A reason code can then be included, and the reason code can clarify the reason for sending the frame in an unsolicited manner. The reason code can indicate that the suitable candidate list is being provided. In this case, a suitable candidate list can be included in an RNR element.

According to another embodiment, the BTM request frame can carry any of the reason codes as listed in Table 4. The transmitting AP MLD can include a neighbor report (NR) element for each AP whose information is provided. The disassociation imminent field can be set to 0. The disassociation timer field can carry a reason code that indicates any of the reasons listed in Table 4.

According to another embodiment, the BTM request can include at least one or more of the information items for the reported APs.

TABLE 5
Information items that can be reported for the APs

| Information items | Description |
|---|---|
| BSS load | One or more information items that can describe |
| information | the BSS load information. |
| Basic ML | A basic ML element carrying information on the |
| element | reported AP MLD. |
| SMD element | SMD element if the reported AP is a part of the |
| | same SMD as the reporting SMD. |
| RSNE | RSNE information |
| RSNXE | RSNXE information |

According to some embodiments, the BTM response frame can carry the list of recommended APs and it can be transmitted in an unsolicited manner. The response frame can carry a list of suitable AP MLDs, for example, via including an RNR.

### Example Signaling 2

According to some embodiments, the neighbor report element can contain an encoding to indicate if QoS assurance can be provided at the target AP or not. For example, there can be a 2-bit field called QoS Assured that can take the following values to make the corresponding indications.

TABLE 6
QoS Assured field encoding

| Value | Meaning |
|---|---|
| 00 | Target AP MLD cannot meet the QoS requirements of the |
| | non-AP MLD. For example, the target AP MLD does not |
| | have the capacity to accept the SCS setups of the |
| | non-AP MLD. |
| 01 | Target AP MLD can meet the QoS requirements of the non- |
| | AP MLD. For example, the target AP MLD has the capacity |
| | to accept the SCS setups of the non-AP MLD. |
| 10 | Target AP MLD's capacity to meet the QoS requirements of |
| | the non-AP MLD can be unknown. |
| 11 | Reserved |

FIG. 22 illustrates an example capabilities subfield format 2200 according to embodiments of the present disclosure. The embodiment of the capabilities subfield format 2200 shown in FIG. 22 is for illustration only. Other embodiments of the capabilities subfield format 2200 could be used without departing from the scope of this disclosure.

As illustrated in FIG. 22, according to one embodiment, the above encoding can be present in the capabilities subfield of the neighbor report element.

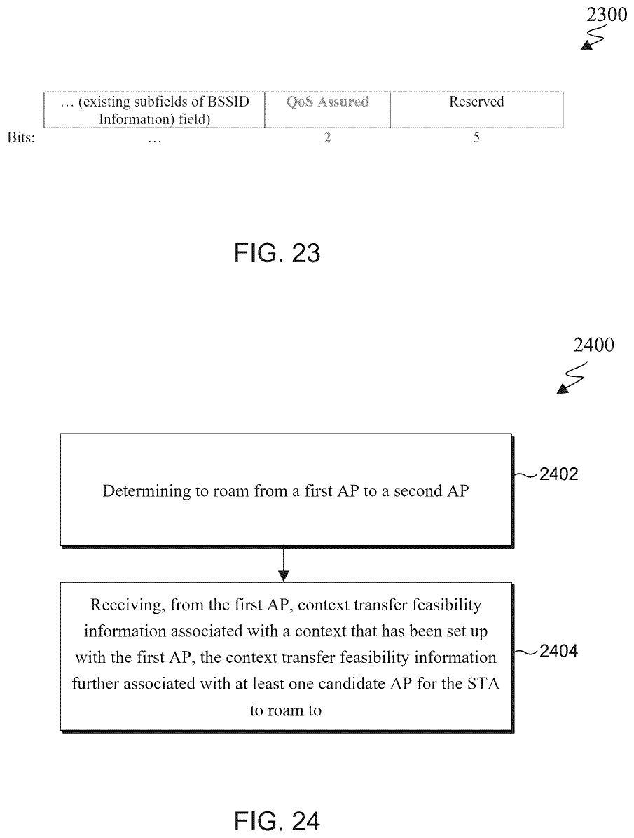

FIG. 23 illustrates an example BSSID information field format 2300 according to embodiments of the present disclosure. The embodiment of the BSSID information field format 2300 shown in FIG. 23 is for illustration only. Other embodiments of the BSSID information field format 2300 could be used without departing from the scope of this disclosure.

As illustrated in FIG. 23, according to one embodiment, the above encoding can be present in the BSSID Information field of the neighbor report.

### Example Behavior

A non-AP MLD can send a BTM Query frame to its current AP MLD to query about neighboring AP MLDs. If the BSS Transition Query Reason field in the BTM Query frame is set to Discovery, the non-AP MLD can include the BSS Candidate List Entries with APs and AP MLDs whose parameters are queried. The BTM Request frame in response to the solicited BTM Request frame can contain only the parameters of the requested APs and AP MLDs.

If the BSS Transition Query Reason field in the BTM Query frame is set to Discovery and the BSS Candidate List Entries is not present, the BTM Request frame in response to the solicited BTM Request frame can contain parameters of all the APs and AP MLDs in the neighborhood of the reporting AP. This can enable a non-AP MLD to obtain the parameters of the neighboring AP MLDs, even if those APs are not known by the STA.

The current AP MLD can respond with a BTM Request frame. The BTM Request frame can include a Neighbor Report for each AP and AP MLD requested by BTM Query frame. If an AP MLD is requested, then the BTM Request frame can contain a Neighbor Report for each affiliated AP.

In the BTM Request frame solicited by a BTM Query with reason codes Discovery, the Neighbor Report elements can include the one or more of the elements shown in Table 5.

In addition, the current AP MLD can send an unsolicited BTM Request frame to the non-AP MLD to provide neighbor AP information.

A BTM Query frame can have the BSS Transition Query Reason field set to Candidate AP Recommendations and the BSS Candidate List Entries can include Neighbor Report elements of the APs and AP MLDs whose suitability as roaming target AP MLD are being queried.

A Neighbor Report element can be included in the BTM Request frame for each affiliated AP to which the target AP MLD can allow the receiving non-AP MLD to setup a link in seamless roaming. Each Neighbor Report element can include a BSS Load sub element, and the Neighbor Report element can set the QoS Assured field, if the reported AP or the reported APs of the AP MLD have capacity to meet the QoS characteristics of the SCS Streams of the receiving non-AP MLD.

The above embodiments can be used for both single and multi-link operations.

In one or more embodiments herein, the term AP and AP MLD may be used interchangeably.

In this disclosure, the terms SMD and seamless roaming domain are used interchangeably.

### B. RSSI Measurement Techniques for Roaming

### 1. Quick RSSI Measurement Procedures

According to some embodiments, a STA can transmit a request frame and receive a response frame that can be received without an additional channel access. For instance, the response can be sent after a SIFS duration after the request is sent. This can enable the device to perform a quick RSSI measurement and return to its original channel quickly.

According to some embodiments, the device can request an NDP from the AP. This can enable the STA to perform the measurements of RSSI.

According to some embodiments, the STA can send an NDPA followed by an NDP and receive a compressed beamforming report from the AP.

According to some embodiments, the STA can transmit an RTS to the candidate/target AP with a duration that is enough to cover just the transmission of the CTS. The AP can respond with a CTS. This can enable the STA to measure the RSSI and return back to the current AP's channel quickly.

According to some embodiments, the STA can transmit any class 1 frame to receive a response frame that can enable a measurement of RSSI. For example, the STA may not be associated with the current AP and may need to transmit a class 1 frame to receive a response frame.

According to some embodiments, the STA can transmit any class 1-4 frame to receive a response frame to measure RSSI. For example, the STA may be associated with an SMD, and the target/candidate AP may share the association context with the STA. In this case, the target/candidate AP can transmit a response frame to any class 1-4 frame as the STA is already associated with it.

According to some embodiments, if an AP receives an RTS from a STA that is associated with an SMD, then the SMD can send a CTS to it even if it is not communicating with the STA on the link. The MAC address of the STA can be distributed via its current AP to all the APs in the SMD.

According to some embodiments, the STA can transmit a defer/blocking signal to clear the channel and perform RSSI measurements.

According to some embodiments, the STA can transmit an RTS at a DIFS boundary and receive a CTS after SIFS duration.

According to some embodiments, when the STA is EPCS authorized/capable it can make use of an enhanced EDCA parameter set to send the probe request or any request frame to receive a response frame. The enhanced EDCA parameter set can be provided by the current AP.

According to some embodiments, when the request frame is received, the response frame can be transmitted at a predetermined/pre-known/reference power level. The power level can be known at the STA side.

According to some embodiments, when the request frame is an NDPA, the STA can measure RSSI from multiple APs. The identifiers (e.g., BSSID) of multiple APs can be specified in the NDPA.

According to some embodiments, when the AP identifiers are specified, the order in which they are specified can be the order in which the NDPs are sent to the STA.

### 2. Capability Advertisement

APs/mobility domains that support such procedures can advertise the capability in one or more frames that they transmit. For example, management frames such as beacons.

### 3. Measurement Mode Based RSSI Measurement

According to some embodiments, there can be a measurement mode which can be setup to enable the quick RSSI measurement procedures described above.

According to this embodiment, there can be a mode request message that can be transmitted by a STA to the AP or alternatively by one STA (non-AP/AP) to another STA (non-AP/AP). The mode request message can consist of at least one or more of the information items as shown in Table 7.

TABLE 7
Information items that can be present in the mode request message

| Information | |
|---|---|
| items | Description |
| Mode type | One or more information items that can indicate |
| | that the measurement mode is one based on the use |
| | of one or more of the quick RSSI measurement |
| | techniques described above. For example, a mode |
| | field which can take a predetermined value to make |
| | the indication and to another predetermined value |
| | to indicate otherwise. |
| Mode | One or more information items that can indicate the |
| characteristics | characteristics of the measurement mode. For example, |
| | measurement duration(s), BSSID, etc. |

According to one embodiment, there can be a response message for the request message. The response message can contain at least one or more of the information items as shown in Table 8.

TABLE 8
Information items that can be present in the mode response frame

| Information | |
|---|---|
| items | Description |
| Response | One or more information items that can indicate a |
| information | response information. For example, a status code |
| | indicating success or failure. |
| Alternative | One or more information items that can indicate an |
| parameters | alternative set of mode characteristics that can |
| | be acceptable to the receiving STA. |
| Reason | One or more information items that can indicate the |
| information | reason for the response. For example, a reason code |

According to another embodiment, the response message can be optional.

According to one embodiment, there can be a report which can be transmitted to the STA. The report can contain information on the measurements performed. The report message can also enable the STA receiving the request to perform measurements and report to the STA transmitting the request.

According to some embodiments, the modified beacon request message can be transmitted to any AP in the same SSID as the current AP.

According to some embodiments, the modified beacon request message can be transmitted to any AP that supports such a measurement process.

According to some embodiments, the modified beacon request message can be transmitted to any AP via the current AP.

According to some embodiments, the STA can receive the beacon request message from its current AP.

### 4. Example Signaling

### 4.1 Enhanced Beacon Report Framework

According to one embodiment, the above quick RSSI measurement modes can be setup by using a modified beacon report framework.

a. Modified Beacon Request

According to this embodiment, an additional measurement mode can be defined for beacon request as shown in Table 9.

TABLE 9
Additional measurement mode for beacon request frame

| Mode | Value |
|---|---|
| Passive | 0 |
| Active | 1 |
| Beacon Table | 2 |
| RTS/Active | 3 |
| Reserved | 4-255 |

The measurement mode field of the beacon request can be set to a value of 3 to indicate a quick RSSI measurement mode by using RTS/CTS method outlined above.

b. Modified Beacon Report

In the beacon report, the reported frame type subfield in the reported frame information field can take a predetermined value (e.g., 1) to indicate that the type of frame reported is a CTS frame.

It can also take a predetermined value to indicate that the reported frame is an RTS frame. For example, when the uplink RSSI is measured and reported by an AP using the RTS frame.

The RCPI field can indicate the received channel power of the CTS (or RTS frame), and it can be a logarithmic function of the received signal power.

The RSNI field can indicate the received signal-to-noise indication for the CTS (or RTS frame).

The BSSID field can contain the BSSID from the RTS frame that solicited a CTS frame.

c. RSSI Measurement Procedure

If the measurement mode of the measurement request is RTS/Active, the measuring STA can perform the measurements on the requested channel by the following procedure:
Transmit an RTS frame at the 20 MHz primary channel to the BSSID field of the measurement request frame/beacon request.
Set the measurement duration
At the end of the measurement duration, generate one or more measurements obtained based on the CTS solicited by the RTS sent by the measuring STA.

According to some embodiments, transmitting a beacon report can be optional when the mode is RTS/Active. In this case, the beacon request can just be used to create an awareness about the possibility that the measuring STA can transmit an RTS to the AP to receive CTS to perform RSSI measurements.

### C. Unavailability Handling for Roaming in Next Generation WLANs

### 1. Pause/Termination of Co-Ex

According to some embodiments, the STA can pause/terminate its Co-Ex indication made to the AP. The STA can transmit a message to the AP to convey the pause/terminate its unavailability. The message can contain an indication that the STA intends to pause/terminate its unavailability. For example, the STA can transmit an OMN (operating mode notification) frame to the AP with a bit that is set to a predetermined value (e.g., 0) to indicate the pause/termination of Co-Ex constraint.

### 2. Roaming Related Exception

According to one embodiment, when triggering any roaming related procedure, the STA can ignore any prior unavailability indications made to the AP. When the STA initiates a roaming related procedure, the AP can also ignore the previously indicated unavailability indications or consider them to be terminated unless reset up/unpaused by the STA at a later point in time.

### 3. Implicit Indication

According to one embodiment, reception of any packet from the STA can be considered as an indication for termination of unavailability by the STA.

### 4. Context Transfer

According to one embodiment, when a STA indicates its unavailability and later initiates roaming procedure, the Co-Ex constraint parameters of the STA/updated parameters transmitted by the STA can be transferred to the target AP to reduce signaling by the STA to perform a reset up with the target AP.

The embodiments herein can be used for any kind of unavailability procedure handling as well.

FIG. 24 illustrates an example method 2400 performed by a STA in a wireless communication system according to embodiments of the present disclosure. The method 2400 of FIG. 24 can be performed by any of the STAs 111-114 of FIG. 1, such as the STA 111 of FIG. 3. The method 2400 is for illustration only and other embodiments can be used without departing from the scope of the present disclosure.

As illustrated in FIG. 24, the method 2400 begins at step 2402, where the STA determines to roam from a first AP to a second AP. At step 2404, the STA receives, from the first AP, context transfer feasibility information associated with a context that has been set up with the first AP, the context transfer feasibility information further associated with at least one candidate AP for the STA to roam to.

In some embodiments, the context transfer feasibility information includes at least one of: an information item indicative of a response message that provides the at least one candidate AP for the STA to roam to; an information item that indicates a candidate AP identifier; an information item that indicates whether context transfer is feasible or not feasible; and an information item that indicates a deadline for a context transfer feasibility indication.

In some embodiments, the STA transmits, to the first AP, a context transfer feasibility request message, the context transfer feasibility request message including at least one of: an information item that indicates a request for a context transfer feasibility check; an information item that indicates a candidate AP identifier; an information item that indicates whether a context is a preferred context or is not a preferred context; and an information item that indicates a deadline for the context transfer feasibility indication.

In some embodiments, the context transfer feasibility request message comprises a request for recommending at least one neighbor AP to which the context can be transferred to, the request for recommending the at least one neighbor AP based on a basic service set transition management (BTM) framework, and the STA transmits, to the first AP, a BTM query associated with context parameters of the at least one neighbor AP; and receives, from the first AP, a BTM response including a neighbor report associated with the context of the at least one neighbor AP.

In some embodiments, the neighbor report includes an information item associated with quality of service.

In some embodiments, the context transfer feasibility information includes information associated with stream classification service (SCS).

In some embodiments, the context transfer feasibility information includes suggested parameters associated with target wake time.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A station (STA) comprising:
a transceiver; and
a processor operably coupled with the transceiver, the processor configured to:
determine to roam from a first access point (AP) to a second AP; and
receive, via the transceiver from the first AP, context transfer feasibility information associated with a context that has been set up with the first AP, the context transfer feasibility information further associated with at least one candidate AP for the STA to roam to.

2. The STA of claim 1, wherein the context transfer feasibility information includes at least one of:
an information item indicative of a response message that provides the at least one candidate AP for the STA to roam to;
an information item that indicates a candidate AP identifier;
an information item that indicates whether context transfer is feasible or not feasible; and
an information item that indicates a deadline for a context transfer feasibility indication.

3. The STA of claim 2, wherein the processor is further configured to transmit, to the first AP via the transceiver, a context transfer feasibility request message, the context transfer feasibility request message including at least one of:
an information item that indicates a request for a context transfer feasibility check;
an information item that indicates a candidate AP identifier;
an information item that indicates whether a context is a preferred context or is not a preferred context; and
an information item that indicates a deadline for the context transfer feasibility indication.

4. The STA of claim 3, wherein:
the context transfer feasibility request message comprises a request for recommending at least one neighbor AP to which the context can be transferred to, the request for recommending the at least one neighbor AP based on a basic service set transition management (BTM) framework, and
the processor is further configured to:
transmit, to the first AP via the transceiver, a BTM query associated with context parameters of the at least one neighbor AP; and
receive, from the first AP via the transceiver, a BTM response including a neighbor report associated with the context of the at least one neighbor AP.

5. The STA of claim 4, wherein the neighbor report includes an information item associated with quality of service.

6. The STA of claim 1, wherein the context transfer feasibility information includes information associated with stream classification service (SCS).

7. The STA of claim 1, wherein the context transfer feasibility information includes suggested parameters associated with target wake time.

8. A first access point (AP) comprising:
a transceiver; and
a processor operably coupled with the transceiver, the processor configured to:
receive, via the transceiver, an indication that a station (STA) has determined to roam from the first AP to a second AP; and
transmit, via the transceiver, context transfer feasibility information associated with a context that has been set up with the first AP, the context transfer feasibility information further associated with at least one candidate AP for the STA to roam to.

9. The first AP of claim 8, wherein the context transfer feasibility information includes at least one of:
an information item indicative of a response message that provides the at least one candidate AP for the STA to roam to;
an information item that indicates a candidate AP identifier;
an information item that indicates whether context transfer is feasible or not feasible; and
an information item that indicates a deadline for a context transfer feasibility indication.

10. The first AP of claim 9, wherein the processor is further configured to receive, from the STA via the transceiver, a context transfer feasibility request message, the context transfer feasibility request message including at least one of:
an information item that indicates a request for a context transfer feasibility check;
an information item that indicates a candidate AP identifier;
an information item that indicates whether a context is a preferred context or is not a preferred context; and
an information item that indicates a deadline for the context transfer feasibility indication.

11. The STA of claim 10, wherein:
the context transfer feasibility request message comprises a request for recommending at least one neighbor AP to which the context can be transferred to, the request for recommending the at least one neighbor AP based on a basic service set transition management (BTM) framework, and
the processor is further configured to:
receive, from the STA via the transceiver, a BTM query associated with context parameters of the at least one neighbor AP; and
transmit, to the STA via the transceiver, a BTM response including a neighbor report associated with the context of the at least one neighbor AP.

12. The first AP of claim 11, wherein the neighbor report includes an information item associated with quality of service.

13. The first AP of claim 8, wherein the context transfer feasibility information includes information associated with stream classification service (SCS).

14. The first AP of claim 8, wherein the context transfer feasibility information includes suggested parameters associated with target wake time.

15. A method of wireless communication performed by a station (STA), the method comprising:
determining to roam from a first access point (AP) to a second AP; and
receiving, from the first AP, context transfer feasibility information associated with a context that has been set up with the first AP, the context transfer feasibility information further associated with at least one candidate AP for the STA to roam to.

16. The method of claim 15, wherein the context transfer feasibility information includes at least one of:
an information item indicative of a response message that provides the at least one candidate AP for the STA to roam to;
an information item that indicates a candidate AP identifier;
an information item that indicates whether context transfer is feasible or not feasible; and
an information item that indicates a deadline for a context transfer feasibility indication.

17. The method of claim 16, further comprising transmitting, to the first AP, a context transfer feasibility request message, the context transfer feasibility request message including at least one of:
an information item that indicates a request for a context transfer feasibility check;
an information item that indicates a candidate AP identifier;
an information item that indicates whether a context is a preferred context or is not a preferred context; and
an information item that indicates a deadline for the context transfer feasibility indication.

18. The method of claim 17, wherein the context transfer feasibility request message comprises a request for recommending at least one neighbor AP to which the context can be transferred to, the request for recommending the at least one neighbor AP based on a basic service set transition management (BTM) framework, the method including:
transmitting a BTM query to the first AP, the BTM query associated with context parameters of the at least one neighbor AP; and
receiving a BTM response from the first AP, the BTM response including a neighbor report associated with the context of the at least one neighbor AP.

19. The method of claim 18, wherein the neighbor report includes an information item associated with quality of service.

20. The method of claim 15, wherein the context transfer feasibility information includes:
information associated with stream classification service (SCS); or
suggested parameters associated with target wake time.
